(19) United States
(12) Patent Application Publication
(10) Pub. No.: US 2011/0087553 A1
(43) Pub. Date: Apr. 14, 2011

(54) BITRATE PREVIEW FOR VIDEO OBJECTS

(75) Inventors: Sumit Mishra, Santa Clara, CA (US); Priyanka Jain, Mountain View, CA (US); Kishore Nair, Fremont, CA (US)

(73) Assignee: YAHOO! INC., Sunnyvale, CA (US)

(21) Appl. No.: 12/579,163

(22) Filed: Oct. 14, 2009

(51) Int. Cl. G06Q 30/00; H04N 7/26; G06F 17/00

(52) U.S. Cl. 705/14.73; 375/240.02; 715/205; 375/E07.127

(57) ABSTRACT

Techniques are provided for enabling videos to be included in online advertisements. Multiple versions of a video are generated that have different bitrates. The multiple versions are enabled to be previewed so that acceptable quality videos are made available to be included in online advertisements. A version that is of unacceptable quality may be rejected. When an online advertisement is to be displayed, a video is selected from the versions that passed the preview (were not rejected) to be included in the online advertisement. The video is selected according to the bandwidth of electronic device that is used to download and view the online advertisement.

### BACKGROUND OF THE INVENTION

1. Field of the Invention

The present invention relates to the accessing of network-based electronic video files.

2. Background

According to one definition, advertising is a paid, one-way communication through a medium in which an advertiser is identified, and the message (i.e., the advertisement) provided by the advertiser is controlled. Advertising may be performed for a variety of purposes, including publicity, public relations, product placement, sponsorship, underwriting, and sales promotion. A variety of mediums are used to convey an advertisement, including television, radio, movies, magazines, newspapers, the Internet, and billboards.

Online advertising relates to the promoting of products and services using the Internet and World Wide Web. Online advertising generally includes displaying an advertisement for a product or service in a user's browser when the user is navigating the Internet. A particular advertisement that is displayed at a given time may have been selected based upon an online context into which the user has navigated, or in some instances upon a historical record of the user's online navigation behavior. When a user clicks on a displayed advertisement, the user may be directed to a website specific to the advertisement, or may be directed to a website that enables purchase of the product or service that is advertised. Typical online advertisement types include banner ads, floating ads, and pop-up ads, which are provided through a browser to the user's computer desktop. Online advertisements may include various forms of content, including text, images, audio, and video.

A business or other entity may generate a portfolio of advertisements available to be displayed online. The advertisements may be configured to advertise various services and/or products of the business. The business may contract to have their advertisements displayed at the online locations (e.g., web pages) of any number of content publishers. A user (e.g., a consumer) may view an advertisement by viewing a web page in which the advertisement is displayed. In the case of advertisements that include video files, the quality of display of video of the video file may depend on a bandwidth of the user's connection. As such, techniques are desired for enabling online advertisements to be generated that display sufficiently well for a variety of connection bandwidths.

### BRIEF SUMMARY OF THE INVENTION

Techniques are provided for enabling videos to be included in online advertisements. Multiple versions of a video are generated that have different bitrates. The multiple versions are enabled to be previewed so that acceptable quality videos are made available to be included in online advertisements. A version of the multiple versions that is of unacceptable quality may be rejected. When an online advertisement is to be displayed, a video is selected from the versions that passed the preview (was not rejected) to be included in the online advertisement. The video is selected according to the bandwidth of electronic device that is used to download and view the online advertisement.

In one implementation, a method for configuring an online advertisement is provided. A user is enabled to provide a video source object. The video source object is optionally validated to determine whether the video source object meets at least one predetermined encoding factor. The video source object is encoded to generate a plurality of encoded video objects, each encoded video object having a corresponding bit rate. The user is enabled to preview each of the plurality of encoded video objects. The user is enabled to select at least one of the encoded video objects to be included in an online advertisement.

When an online advertisement is displayed, an encoded video object of the plurality of encoded video objects that were not rejected is selected to be displayed in the online advertisement. The encoded video object is selected according to a bandwidth of a connection with an electronic device having requested the online advertisement. If the connection bandwidth is relatively high, an encoded video object having a relatively high bitrate may be selected. If the connection bandwidth is relatively low, an encoded video object having a relatively low bitrate may be selected.

In another implementation, a system for configuring online advertisements is provided. The system includes a user interface generator, a video object validator, and an encoding module. The user interface generator is configured to generate a user interface that enables a user to provide a video source object. The video object validator is configured to validate the video source object to determine whether the video source object meets at least one predetermined encoding factor. The encoding module is configured to encode the video source object to generate a plurality of encoded video objects, each encoded video object having a corresponding bit rate. The user interface is configured to enable the user to preview each of the plurality of encoded video objects, to optionally reject one or more of the encoded video objects based on the preview, and to enable the user to select at least one of the plurality of encoded video objects to be included in an online advertisement.

Computer program products are also described herein. The computer program products include a computer-readable medium having computer program logic recorded thereon for enabling multiple encoded versions of a video object to be generated that have corresponding bit rates, for enabling the encoded versions to be previewed, and for enabling the encoded versions to selectively be included in online advertisements.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a block diagram of a computer that a user may use to view content.

FIG. 2 shows an example search results page that may result from a user submitting a query to a search engine.

FIG. 3 shows a block diagram of an online advertisement object.

FIG. 4 shows a block diagram of a page being displayed that includes an online advertisement having a video.

FIG. 5 is a block diagram of an example online advertisement (“ad”) network in accordance with an embodiment of the present invention.

FIG. 6 shows a flowchart for processing video objects for including in online advertisements, according to example embodiments.

FIG. 7 shows a block diagram of a creative asset processing system, according to an example embodiment.

FIG. 8 shows a flowchart for processing video objects for including in online advertisements, according to example embodiments.

FIG. 9 shows an example user interface for enabling a user to provide a video source object, according to an embodiment.

FIG. 10 shows a block diagram of a creative asset processing system, according to an example embodiment.

FIG. 11 shows a flowchart for encoding a video object, according to example embodiments.

FIG. 12 shows a block diagram of an encoding module, according to an example embodiment.

FIG. 13 shows an example user interface for enabling a user to select a video source object to view corresponding encoded video objects, according to an embodiment.

FIG. 14 shows an example user interface for enabling a user to preview encoded video objects for a selected video source object, according to an embodiment.

FIG. 15 shows a process for enabling a user to generate an online advertisement, according to an example embodiment.

FIG. 16 shows an advertisement serving system that includes an encoded video object selector, according to an example embodiment.

FIG. 17 shows a block diagram of an example computer system in which embodiments of the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

### II. Examples of Online Advertising

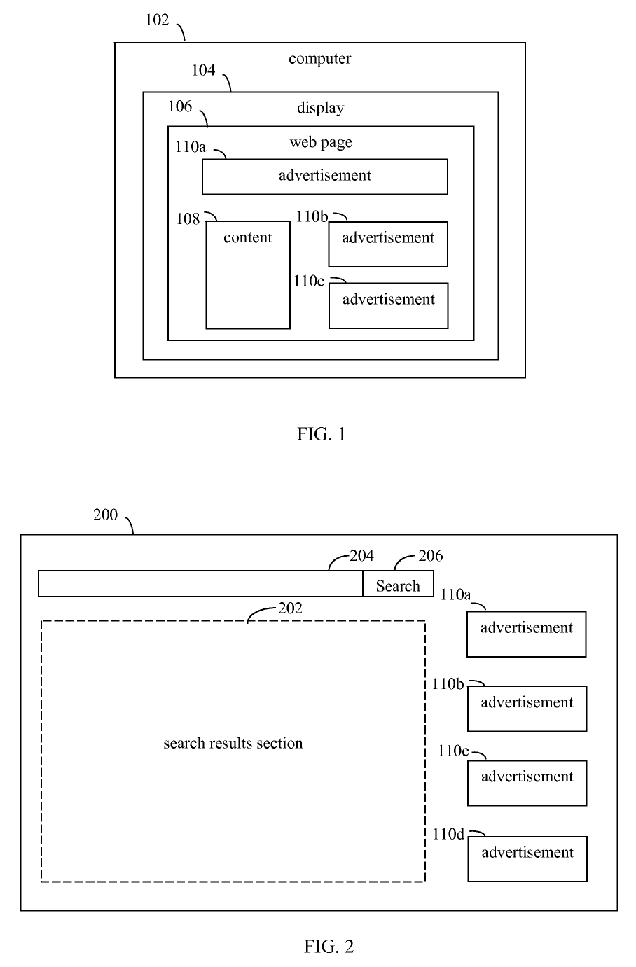

Embodiments of the present invention relate to online advertising. FIGS. 1 and 2 show examples of the displaying of advertisements in various environments. For instance, FIG. 1 shows a block diagram of a computer 102 that a user may use to view online content. As shown in FIG. 1, a display 104 of computer 102 displays a web page 106 open in a web browser. As shown in FIG. 1, web page 106 includes content 108. Furthermore, web page 106 may include any number and arrangement of advertisements, including advertisements 110a-110c shown in FIG. 1. Advertisements 110a-110c may have any suitable form, including being banner ads, floating ads, and pop-up ads. In the example of FIG. 1, advertisement 110a is shown as a banner ad at the top of web page 106 (e.g., a North banner advertisement), and advertisements 110b and 110c are both positioned adjacent to a right edge of web page 106.

FIG. 2 shows an example search results page 200 that may result from a user submitting a query to a search engine. Search results page 200 may also be displayed by computer 102 of FIG. 1. As shown in FIG. 2, search results page 200 includes a search results section 202, a data entry box 204, and a search button 206. Data entry box 204 defines a user-editable area into which one or more query terms may be entered. When activated, search button 206 causes the search engine to execute a document search based on the query term(s) entered in data entry box 204. Search results section 202 is used to display information about documents identified by the search engine in response to the submitted search query. Search results page 200 may include any number and arrangement of advertisements, including advertisements 110a-110d shown in FIG. 2. Advertisements 110a-110d may be sponsored search ads associated with particular queries, for example.

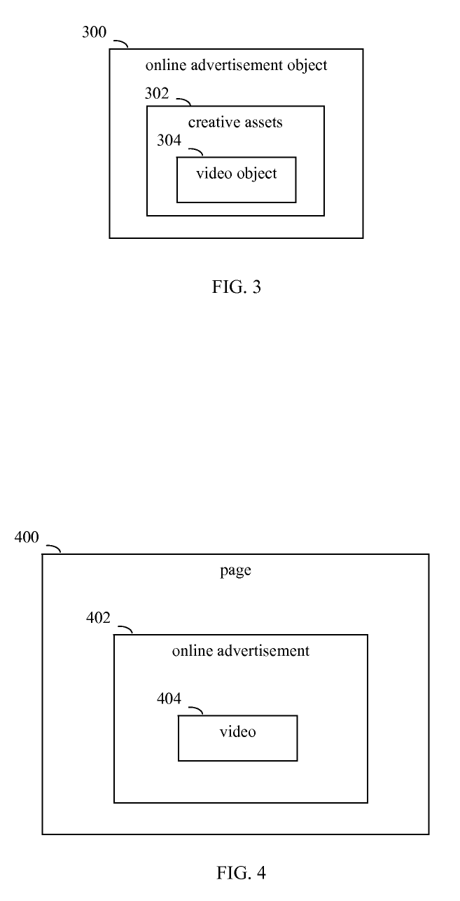

An entity, such as a business, may generate a portfolio of advertisements available to be displayed online on web pages, such as web page 106 and search results page 200. Online advertisements may be generated that include various forms of content, including text, images, audio, and video. For example, FIG. 3 shows a block diagram of an online advertisement object 300. Online advertisement object 300 includes one or more files and/or further objects representative of an online advertisement. As shown in FIG. 3, online advertisement object 300 includes one or more creative assets 302. Examples of creative assets 302 include text, images, audio, and video. For example, as shown in FIG. 3, creative assets 302 may include a video object 304, which may be a file or other object that includes video media.

In the embodiment of FIG. 3, online advertisement object 300 may be transmitted to a browser (e.g., from an advertisement server) to be displayed in a web page. For instance, FIG. 4 shows a block diagram of a page 400 that may be displayed by an electronic device (e.g., by computer 102 of FIG. 1). As shown in FIG. 4, page 400 includes an online advertisement 402 that includes video 404. For example, online advertisement 402 may be displayed in page 400 based on online advertisement object 300, and video object 304 may be executed (e.g., “played” by a video media playing device, such as a browser plug-in, etc.) to display video 404.

In FIG. 4, the quality of display of video 404 may depend on a bandwidth of the user's connection. As such, it may be desirable for online advertisement 402 to provide multiple versions of video object 304, with each version configured for a corresponding network bandwidth. Depending on the bandwidth of the user's connection, the appropriate version of video object 304 may be played when online advertisement 402 is displayed.

Embodiments are described herein for enabling online advertisements to be generated and displayed that have multiple video file versions available.

### III. Example Embodiments

Embodiments of the present invention are described herein for enabling online advertisements to be generated and displayed that provide multiple video file versions. For illustrative purposes, some example embodiments are described with regard to the display of advertisements in web pages. However, in alternative embodiments, advertisements as described herein may be displayed in other electronic form, including in widgets (e.g., desktop widgets such as Yahoo!® Widgets, Google® panels or gadgets, etc.), in text messages, and/or in/with other electronic content.

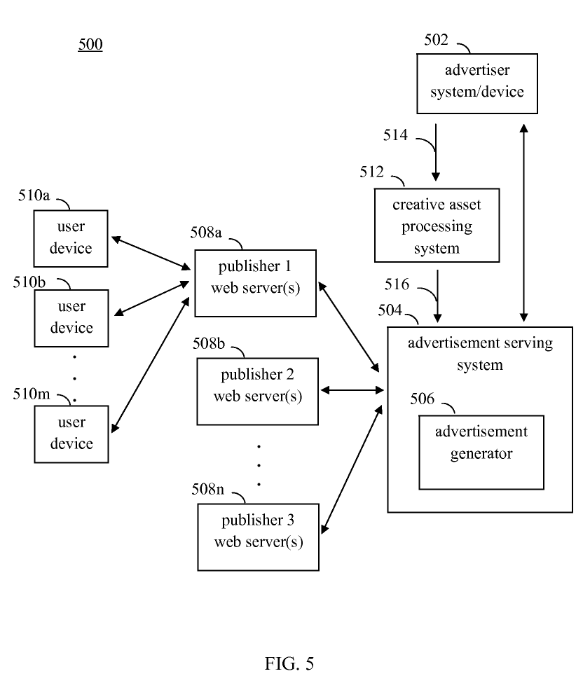

FIG. 5 is a block diagram of an example online advertisement (“ad”) network in accordance with an embodiment of the present invention. Generally speaking, online ad network 500 operates to serve online ads (e.g., online advertisement object 300 of FIG. 3) provided by advertisers to Web sites published by publishers when such Web sites are accessed by users of the network, thereby delivering the online ads to the users. As shown in FIG. 5, online ad network 500 includes at least one advertiser system/device 502, an ad serving system 504, a plurality of publisher Web servers 508a-508n, a plurality of user systems/devices 510a-510m, and a creative asset processing system 512.

Each of publisher Web servers 508a-508n is configured to host a Web site published by a corresponding publisher so that such Web site is accessible to users of network 500. A user may access such Web sites using a Web browser or other Web client installed on a system/device owned by or otherwise accessible to the user. By way of example, FIG. 5 shows a plurality of user systems/devices 510a-510m, each of which executes a Web browser that enables a user to visit any of the Web sites hosted by publisher Web servers 508a-508n. As depicted in FIG. 5, each of client systems/devices 510a-510m is communicatively connected to publisher 1 Web server(s) 508a for the purpose of accessing a Web site published by publisher 1. Persons skilled in the relevant art(s) will recognize that each of user systems/devices 510a-510m is capable of connecting to any of publisher Web servers 508a-508n to access the Web sites hosted thereon. Communication between user systems/devices 510a-510m and publisher Web servers 508a-508n is carried out over a wide area network, such as the Internet, using well-known network communication protocols.

Ad serving system 504 is configured to deliver online ads received from an advertiser system/device 502 to each of publisher Web servers 508a-508n when the Web sites hosted by such Web servers are accessed by users, thereby facilitating the delivery of such online ads to the users. For example, ad serving system 504 may receive the online ads directly from an advertiser system/device 502. In another example, ad serving system 104 may include an advertisement generator 506. Advertisement generator 506 is configured to generate online ads based on one or more creative assets received from advertiser system/device 502 through creative asset processing system 512.

Creative asset processing system 106 is configured to process creative assets (e.g., creative assets 302 of FIG. 3) received from the advertiser system/device 102, so that the creative assets may be included in online ads generated by ad generation module 122. Examples of creative assets include but are not limited to video files, audio files, image files, etc. In one example implementation, creative asset processing system 106 may be configured to encode video objects (e.g., video object 304 of FIG. 3) into a designated format. For example, creative asset processing system 106 may be configured to generate a plurality of encoded video objects (e.g., files) corresponding to respective bitrates, based on an uploaded video object 304.

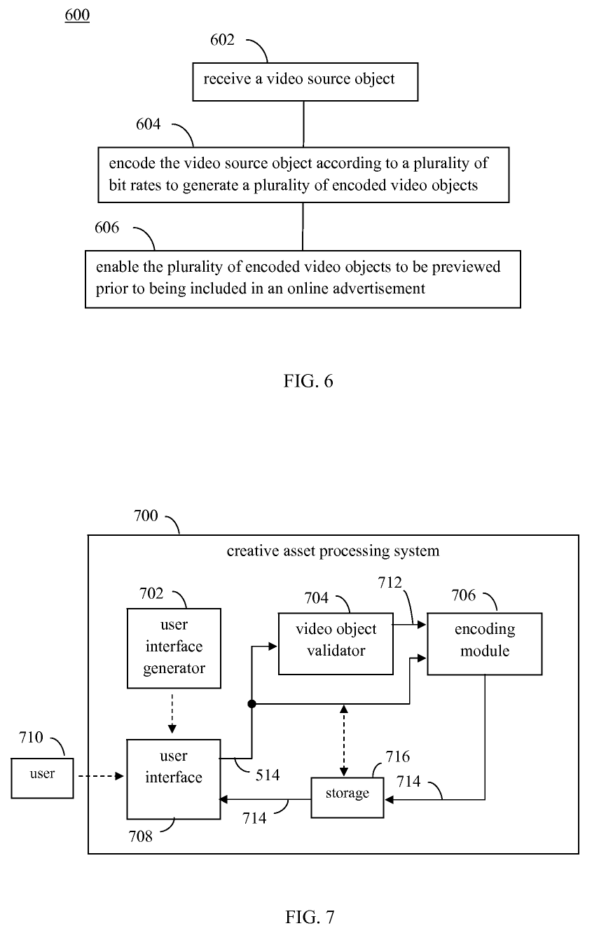

For example, in an embodiment, creative asset processing system 106 may be configured to perform a process shown in FIG. 6. FIG. 6 shows a flowchart 600 for processing video objects for including in online advertisements, according to example embodiments. Further structural and operational embodiments will be apparent to persons skilled in the relevant art(s) based on the discussion regarding flowchart 600. Flowchart 600 is described as follows.

Flowchart 600 begins with step 602. In step 602, a video source object is received. For example, as shown in FIG. 5, creative asset processing system 512 may receive a video source object 514 from advertiser/system device 502. Video source object 514 is an example of video object 304 that may be provided by a user (e.g., advertiser/system device 502) to be incorporated into an online advertisement. For instance, video source object 514 may be a video file having any of a variety of formats, such as Windows Media Video (WMV) format developed by Microsoft Corporation, QuickTime® format developed by Apple Inc., Audio Video Interleave (AVI) format developed by Microsoft Corporation, Motion Picture Experts Group (MPEG) format developed by the Motion Picture Experts Group, etc.

Video source object 514 may be received by creative asset processing system 512 from advertiser/system device 502 in any manner, including using a file transfer protocol (e.g., FTP), by enabling video source object 514 to be uploaded into a user interface provided by creative asset processing system 512 (e.g., a graphical user interface (GUI), a web page, etc.), or by other manner. For example, the user interface may include a graphical user interface (GUI) (e.g., a web page, etc.), and/or may include further user interface elements, such as a keyboard, a thumb wheel, a mouse pointer, a roller ball, a stick pointer, a display, any number of virtual interface elements, a voice recognition system, a haptic interface, and/or other user interface elements described elsewhere herein or otherwise known.

In step 604, the video source object is encoded according to a plurality of bit rates to generate a plurality of encoded video objects. Referring to FIG. 5, in an embodiment, creative asset processing system 512 may be configured to encode video source object 514 to generate a plurality of encoded video objects having corresponding bitrates. Creative asset processing system 512 may be configured according to any of a variety of encoding platforms and/or techniques to encode video source object 514. For instance, creative asset processing system 512 may use open source software, such as FFmpeg (developed by Fabrice Bellard and maintained by Michael Niedermayer) or MPlayer (developed by Arpad Gereoffy and maintained by Alex Beregszaszi); On2 Flix Engine developed by On2 Technologies Inc.; Carbon Coder/Carbon Server developed by Rhozet, which is a business unit of Harmonic, Inc.; a proprietary encoding technique, etc.

The bitrates associated with the encoded video objects generated by creative asset processing system 512 may correspond to respective bandwidths that are available for delivering online ads. Any number of encoded video objects may be generated. For instance, creative asset processing system 512 may be configured to generate five encoded files based on a received video file. Four of the five encoded files may correspond to bitrates of 100 kilobits per second (kbps), 300 kbps, 700 kbps, and 1000 kbps, respectively, for example. These example bitrates are provided for illustrative purposes and are not intended to be limiting. The fifth encoded file may include a thumbnail view of an image associated with the video file. For example, the thumbnail view may be a frame of the video associated with the video file to serve as a preview of the video.

In step 606, the plurality of encoded video objects is enabled to be previewed prior to being included in an online advertisement. For example, in an embodiment, creative asset processing system 512 enables a user (e.g., at advertiser system/device 502) to access each of the generated encoded video objects to preview the generated encoded video objects. Each of the encoded video objects may be previewed to determine whether each encoded video object is suitable for inclusion in an online advertisement. For example, a user may preview the video corresponding to each encoded video object to determine whether or not the encoding process degraded the quality of the video to an extent that the user does not want the corresponding encoded video object to be included in an online advertisement. Creative asset processing system 512 may enable the user to preview the encoded video objects in any manner, including by providing a user interface that enables the user to play and view video for each encoded video object (e.g., a user interface accessible in a web browser at an electronic device of the user). The user may be enabled to select one or more of the encoded video objects as being suitable to be included in an online advertisement, and to potentially reject one or more of the encoded video objects as being unsuitable.

As shown in FIG. 5, creative asset processing system 512 may output one or more selected encoded video objects 516, which includes the one or more encoded video objects that the user determined were suitable for inclusion into an online advertisement. Advertisement generator 506 may receive selected encoded video objects 516, and may generate an online advertisement that includes the selected (non-rejected) encoded video objects.

Creative asset processing system 512 may be configured in various ways to perform flowchart 600, in embodiments. For instance, FIG. 7 shows a block diagram of a creative asset processing system 700, according to an example embodiment. Creative asset processing system 700 is an example of creative asset processing system 512. As shown in FIG. 7, creative asset processing system 700 includes a user interface generator 702, a video object validator 704, an encoding module 706, and storage 716. These elements of creative asset processing system 700 are described as follows.

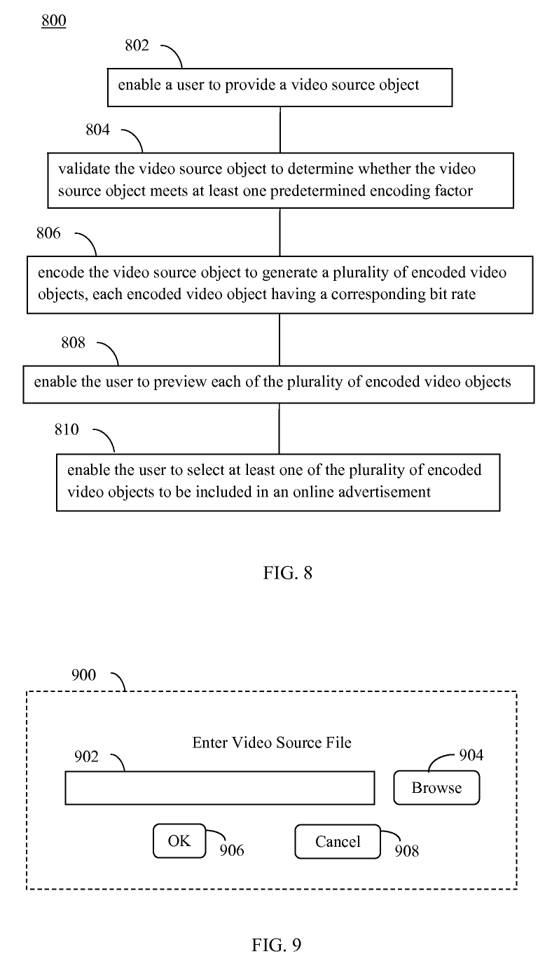

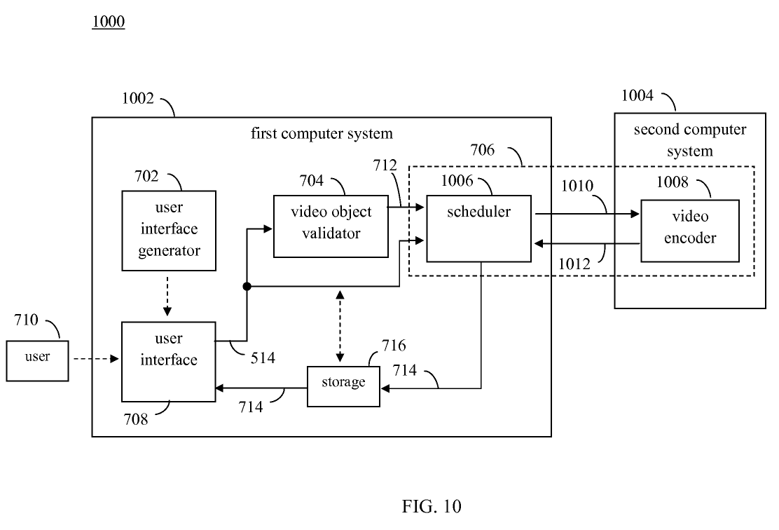

As shown in FIG. 9, user interface generator 702 may be configured to generate a portion or entirety of a user interface 708. User interface 708 may be configured to enable a user 710 (e.g., at advertiser system/device 502) to provide video source object 514 to creative asset processing system 700 (e.g., according to step 602 of flowchart 600). For example, user interface 708 may be a graphical user interface that includes one or more of any combination of user interface elements, including data entry boxes, pull down menus, check boxes, buttons, hyperlinks, and/or other graphical interface element types suitable for enabling user 710 to provide video source object 514. User interface 708 may be displayed to user 710 in a web browser or other web client, a computer-based creative management tool, and/or other mechanism at an electronic device of user 710. Video source object 514 received from user 710 may optionally be stored in storage 716 (as indicated by the dotted line double headed arrow in FIG. 7).

Video object validator 704 may be optionally present in creative asset processing system 700. When present, video object validator 704 may be configured to validate video source objects 514 prior to encoding. For example, video object validator 704 may be configured to determine whether video source object 514 meet one or more predetermined encoding factors such that video source object 514 may be capable of being encoded and/or of being included in an online advertisement. If video source object 514 meets the predetermined encoding factor(s), video object validator 704 outputs a validated video source object indicator 712, which is received by encoding module 706.

Encoding module 706 is configured to encode video source object 514 (e.g., according to step 604 of flowchart 600) to generate a plurality of encoded video objects 714. For example, if validator 704 is present, and validated video source object indicator 712 indicates that encoded video source object 514 is validated, encoding module 706 generates encoded video objects 714. Encoding module 706 may be configured to encode video source object 514 according to any encoding platform or technique described elsewhere herein or otherwise known, including those techniques described above with respect to step 604 of flowchart 600, to generate encoded video objects 714. As shown in FIG. 7, encoded video objects 714 may be stored in storage 716.

Furthermore, user interface 708 may be configured to enable user 710 to preview encoded video objects 714 (e.g., according to step 606 of flowchart 600) that are generated by encoding module 706 based on video source object 514, and to selectively reject one or more of encoded video objects 714 based on the preview. For example, user interface 708 may be a graphical user interface that includes one or more of any combination of user interface elements, including data entry boxes, pull down menus, check boxes, buttons, hyperlinks, and/or other graphical interface element types suitable for enabling user 710 to preview (and reject) encoded video objects 714.

Flowchart 600 of FIG. 6 may be performed in various ways, in embodiments. For instance, FIG. 8 shows a flowchart 800 for processing video objects for including in online advertisements, according to example embodiments. Flowchart 800 is an example of flowchart 600. Further structural and operational embodiments will be apparent to persons skilled in the relevant art(s) based on the discussion regarding flowchart 800. Flowchart 800 is described as follows.

Flowchart 800 begins with step 802. In step 802, a user is enabled to provide a video source object. For example, in an embodiment, user interface generator 702 may generate user interface 708 to enable video source object 514 to be provided by user 710. User interface 708 may be configured in any manner, including one or more user interface elements, to enable a user to provide a video source object. User 710 may be enabled to provide video source object 514 to system 700 in any manner, including using a file transfer protocol, uploading a video source object into a user interface, by email, etc. In an embodiment, user interface 708 may require that user 710 provide credentials, such as a login identifier and password, before enabling the user to provide video source object 514 and/or to otherwise access system 700.

For instance, FIG. 9 shows an example user interface 900 for enabling a user to provide a video source object, according to an embodiment. User interface 900 is an example of user interface 708. As shown in FIG. 9, user interface 900 includes a file name entry box 902, a browse button 904, a complete button 906, and a cancel button 908. In the example of FIG. 9, browse button 904 is displayed adjacent to file name entry box 902, and complete button 906 and cancel button 908 are displayed below file name entry box 902. User 710 may input a file name for video source file 514 in file name entry box 902 (e.g., as indicated by the text “Enter Video Source File”). User 710 may enter the file name textually into file name entry box 902, or by interacting with browse button 904 (e.g., clicking button 904 with a pointer device) to cause a navigator to be displayed in user interface 900. The navigator may enable user 710 to navigate through folders and/or files to locate and select the file name to be entered into file name entry box 902. By interacting with complete button 906 (labeled with “Ok”), the user may cause the video source file having a file name entered in file name entry box 902 to be uploaded to creative asset processing system 700. By interacting with cancel button 908, the user may exit without uploading a video source file.

Note that user interface 900 shown in FIG. 9 is provided for illustrative purposes. In further embodiments, user interface 900 may be configured in other ways to enable a user to provide a video source object.

In step 804, the video source object is validated to determine whether the video source object meets at least one predetermined encoding factor. For example, in an embodiment, video object validator 704 may be configured to validate video source object 514 to determine whether video source object 514 meets one or more predetermined encoding factors. To validate video source object 514, video object validator 704 may be configured to analyze video source object 514 with regard to any number of encoding factors, including a play time (a video duration) of video source object 514, a file size (e.g., a number of bytes) of video source object 514, a file type of video source object 514, dimensions (e.g., width and height of frames) of video associated with video source object 514, a video aspect ratio (e.g., width versus height of frames) of video source object 514, a video frame rate of video source object 514, a video key frame interval of video source object 514, a video sampling rate of video source object 514, a video codec of video source object 514, an audio sampling rate of video source object 514, an audio codec of video source object 514, whether audio of video source object 514 is mono/stereo, etc. If video source object 514 meets the one or more predetermined encoding factors, video object validator 704 generates validated video source object indicator 712.

Note that video object 514 may fail validation by video object validator 704 by not meeting one or more of the predetermined encoding factors. In such a case, the user may be enabled to provide a second video source object to replace video source object 514 (e.g., may repeat step 802 with another video source object).

In step 806, the video source object is encoded to generate a plurality of encoded video objects, each encoded video object having a corresponding bit rate. For example, as described above, encoding module 706 may be configured to encode video source object 514 to generate plurality of encoded video objects 714. Note that in an embodiment, encoding module 706 may be located in a same computer system (e.g., server) as user interface generator 702 and video object validator 704. In another embodiment, encoding module 706 may be located in a separate computer system from user interface generator 702 and/or video object validator 704. In still another embodiment, a portion of encoding module 706 may be located in a computer system separate from user interface generator 702 and/or video object validator 704.

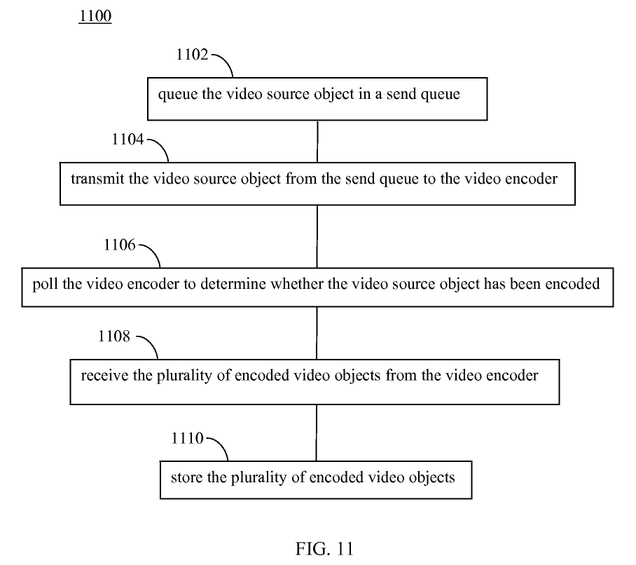

For instance, FIG. 10 shows a block diagram of a creative asset processing system 1000, according to an example embodiment. Creative asset processing system 1000 is an example of creative asset processing system 700 shown in FIG. 7. As shown in FIG. 10, system 100 includes a first computer system 1002 and a second computer system 1004. In the example of FIG. 10, encoding module 706 has a first portion included in first computer system 1002 (with user interface generator 702 and video object validator 704), and a second portion included in second computer system 1004. In the example of FIG. 10, encoding module 706 includes a scheduler 1006 and a video encoder 1008. Scheduler 1006 is included in first computer system 1002, and video encoder 1008 is included in second computer system 1004.

Scheduler 1006 is configured to launch and/or terminate encoding jobs performed by video encoder 1008. As shown in FIG. 10, scheduler 1006 receives validated video source object indicator 712 and video source object 514. Video encoder 1008 is configured to encode video source objects provided by scheduler 1006. For example, as shown in FIG. 10, an encoding job 1010 may be transmitted from scheduler 1006 to video encoder 1008. Encoding job 1010 may include video source object 514. Video encoder 1008 may encode video source object 514 to generate plurality of encoded video objects 714. Encoded video objects 714 may be transmitted from video encoder 1008 to scheduler 1006 in an encoding response 1012. As shown in FIG. 10, scheduler 1006 receives encoding response 1012, and provides plurality of encoded video objects 714 (from encoding response 1012) to storage 714 so that they may be previewed by user 710 (at user interface 708).

Note that in the example of FIG. 10, first and second computer systems 1002 and 1004 may be communicatively coupled (e.g., for transmission of encoding job 1010 and encoding response 1012) in any manner, including by a network, such as a local area network (LAN), a wide area network (WAN), or a combination of networks, such as the Internet.

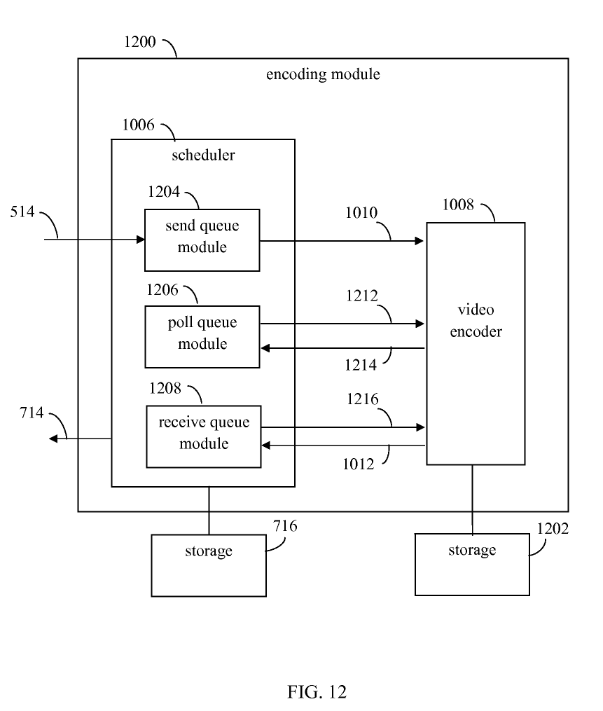

FIG. 11 shows a flowchart 1100 for encoding a video object in step 806, according to example embodiments. For example, flowchart 1100 may be performed by encoding module 706 shown in FIG. 10. Further structural and operational embodiments will be apparent to persons skilled in the relevant art(s) based on the discussion regarding flowchart 1100. Flowchart 1100 is described as follows with respect to FIG. 12. FIG. 12 shows a block diagram of an encoding module 1200, according to an example embodiment. Encoding module 1200 is an example of encoding module 706 shown in FIG. 10. As shown in FIG. 12, encoding module 1200 includes scheduler 1006 and video encoder 1008. Furthermore, as shown in FIG. 12, first storage 716 is coupled to scheduler 1006 and a second storage 1202 is coupled to video encoder 1008.

Flowchart 1100 begins with step 1102. In step 1102, the video source object is queued in a send queue. For example, as shown in FIG. 12, scheduler 1006 includes a send queue module 1204, a poll queue module 1206, and a receive queue module 1208. In an embodiment, scheduler 1006 receives video source object 514, and video source object 514 is included in a send queue maintained by send queue module 1204. For example, video source object 514 may be stored by send queue module 1204 in a send queue that is maintained in first storage 706. The send queue may include one or more video source files that are to be encoded by video encoder 1008. The send queue may be any type of queue, including a first in, first out (FIFO) queue, a last in, first out (LIFO) queue, or other type of queue. Send queue module 1204 may generate an address in storage 706 at which video source object 514 may be accessed, such as a URL address or other type of address.

In step 1104, the video source object is transmitted from the send queue to the video encoder. For example, in an embodiment, send queue module 1204 may be configured to transmit encoding job 1010 to video encoder 1008 (e.g., when video source object 514 reaches the end of the send queue), requesting that video encoder 1008 encode video source object 514. Encoding job 1010 may include video source object 514, and/or may include a file identifier (file ID) for video source object 514 in first storage 706 or in a temporary storage location in which video source object 514 has been stored. After receiving encoding job 1010, video encoder 1008 is configured to encode video source object 514. Video encoder 1008 may receive video source object 514 in encoding job 1010, or may retrieve video source object 514 from storage using the file identifier (when the file identifier is included in encoding job 1010). Video encoder 1008 may encode video source object 514 into plurality of encoded video objects 714, which may be stored in second storage 1202. Video encoder 1008 may encode video source object 514 into any number of different bitrate versions according to any video encoding platform or technique described elsewhere herein or otherwise known.

In step 1106, the video encoder is polled to determine whether the video source object has been encoded. For example, in an embodiment, poll queue module 1206 may poll video encoder 1008 to determine whether video source object 514 has completed being encoded by video encoder 1008. For instance, poll queue module 1206 or send queue module 1204 may be configured to generate a poll time at which the status of the encoding by video encoder 1008 is to be requested, and poll queue module may create a poll queue job to be performed according to the generated poll time (e.g., perform a onetime status check after the poll time expires, perform a periodic status check having a period of the poll time, etc.). The poll time may be calculated based on one or more attributes of video source object 514. Examples of such attributes include a duration of a video associated with video source object 514, a file size of video source object 514, dimensions of the video associated with video source object 514, the type of encoding used to encode video source object 514, etc. Note that in another embodiment, user 710 interacting with user interface 708 may be enabled to initiate the poll queue job (e.g., if user 710 is wondering whether video source object 514 has been encoded), rather than the poll queue job being automatically initiated by poll queue module 1206 or send queue module 1204.

As shown in FIG. 12, poll queue module 1206 may generate a poll status request 1212 for video source file 514 at expiration of the poll time (or according to user 710 input), which is transmitted to video encoder 1008. Poll status request 1212 may include the file identifier included in encoding job 1010 and/or other identifier for video source file 514. In response to poll status request 1212, video encoder 1008 generates a poll status response 1214, which indicates whether the encoding of video source object 514 is complete (or failed, suspended, etc.). Poll status response 1214 is received by poll queue module 1206.

In step 1108, the plurality of encoded video objects is received from the video encoder. For example, in an embodiment, if poll status response 1214 indicates that encoding of video source object 514 is complete, poll queue module 1206 may indicate to receive queue module 1208 that encoded video objects 714 generated from video source object 514 by video encoder 1008 may be received. In such case, receive queue module 1208 may transmit an encoded video object request 1216 to video encoder 1008. Encoded video object request 1216 may include the file identifier included in encoding job 1010 and/or other identifier for video source file 514. In response to encoded video object request 1216, video encoder 1008 may access encoded video objects 714 stored in second storage 1202, and may transmit encoded video objects 714 to receive queue module 1208 in encoding response 1012.

In step 1110, the plurality of encoded video objects is stored. For example, in an embodiment, receive queue module 1208 may store encoded video objects 714 (received in encoding response 1012) in first storage 716. For example, first storage 716 may contain a creative asset database/library that may include many video source files and associated encoded video files, and may include further creative assets used to generate online advertisements. Encoded video objects 714 may be stored in first storage 716 in association with video source file 514. Receive queue module 1208 may generate addresses in storage 706 at which each of encoded video object 714 may be accessed, such as URL or other types of address.

Referring back to flowchart 800 in FIG. 8, in step 808, the user is enabled to preview each of the plurality of encoded video objects. For example, as described above with respect to FIG. 7, user interface 708 may enable user 710 to preview each of encoded video objects 714 generated as encoded versions of video source object 514. User interface 708 may be configured in any manner, including one or more user interface elements, to enable user 710 to preview encoded video objects 714. In an embodiment, user interface 708 may require that user 710 provide credentials, such as a login identifier and password, before enabling the user to preview encoded video objects 714 and/or otherwise access system 700.

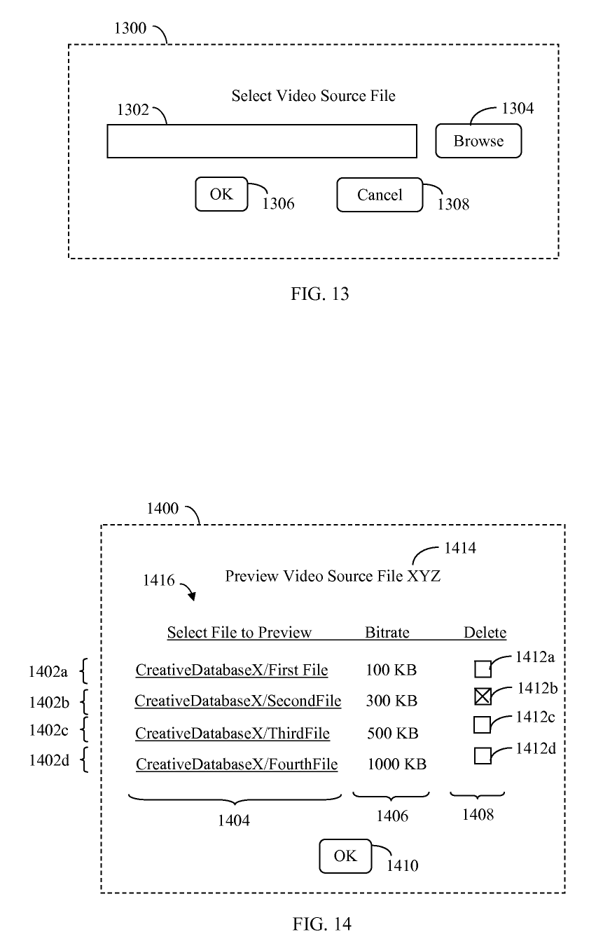

For instance, FIG. 13 shows an example user interface 1300 for enabling a user to select a video source object in order to preview corresponding encoded video objects, according to an embodiment. User interface 1300 is an example of user interface 708. As shown in FIG. 13, user interface 1300 includes a file name entry box 1302, a browse button 1304, a complete button 1306, and a cancel button 1308. In the example of FIG. 13, browse button 1304 is displayed adjacent to file name entry box 1302, and complete button 1306 and cancel button 1308 are displayed below file name entry box 1302. User 710 may input a file name in file name entry box 1302 to select a video source file (e.g., as indicated by the text “Select Video Source File”) having encoded video files to preview. User 710 may enter the file name textually into file name entry box 1302, or by interacting with browse button 1304 (e.g., clicking with a pointer device) to cause a navigator to be displayed in user interface 1300. The navigator may enable user 710 to navigate through folders and/or files in storage 716 to locate and select the video source object. By interacting with complete button 1306 (labeled with “Ok”), the user may cause encoded video objects associated with the selected video source file to be made available for preview. By interacting with cancel button 1308, the user may exit without uploading a video source file.

Note that user interface 1300 shown in FIG. 13 is provided for illustrative purposes. In further embodiments, user interface 1300 may be configured in other ways to enable user 710 to preview encoded video objects. For example, in an embodiment where user 710 provides login credentials to access system 700, a list of video source objects previously provided by the user may be displayed by user interface 1300 to the user upon login. The user may select a listed video source object (e.g., a hyperlink) to be enabled to preview the associated encoded video objects.

After selecting a video source object to preview the corresponding encoded video objects, user interface 708 may display the encoded video objects for preview. For example, FIG. 14 shows an example user interface 1400 for enabling a user to preview encoded video objects for a selected video source object, according to an embodiment. User interface 1400 is an example of user interface 708. As shown in FIG. 14, user interface 1400 includes a selected video source object indicator 1414 and a table 1416 that includes a plurality of rows 1402, with each row 1402 corresponding to an encoded video object generated by encoding module 706. Although in the example of FIG. 14, four rows 1402a-1402d are included in table 1416 corresponding to four encoded video objects, in embodiments, any number of rows may be displayed, depending on the number of encoded video objects generated.

As shown in FIG. 14, table 1416 includes a first column 1404, a second column 1406, and a third column 1408. First column 1404 lists file names for each of the encoded video objects, second column 1406 lists bitrates for each of the encoded video objects, and third column 1408 includes a graphical interface element for each encoded video object to enable selective deletion. For example, the file names listed in first column 1404 may be hyperlinks that when selected by a user (e.g., user 710) may cause a video corresponding to the particular encoded video object to be played (displayed) in user interface 1400 for preview. The file names listed in first column 1404 may have any format, including being in the form of URLs or other type of address for the filenames. For example, a URL address provided in first row 1402a for a first encoded video object is shown as “CreativeDatabaseX/FirstFile”, which may be a URL address for the first encoded video object in storage 716.

The bitrates listed second column 1406 may have any form, including in the form of kilobytes (KB), megabytes (MB), etc. For example, in FIG. 14, the bitrate indicated in row 1402a for the first encoded video object is 100 KB.

Third column 1408 is optionally present. In the example of FIG. 14, selection boxes 1412a-1412d are shown in third column 1408, which may be checked or left unchecked to respectively delete or leave undeleted the corresponding encoded video objects. For instance, the user may preview a particular encoded video object, may determine that the encoded video object is unsuitable for including in an online advertisement, and thus may check the corresponding selection box 1412 to have the encoded video object deleted. In the example of FIG. 14, selection box 1412a is not shown as checked for the encoded video object in first row 1402a, indicating that the first encoded video object should not be deleted. Selection box 1412b is shown as checked for the encoded video object in second row 1402b, indicating that the second encoded video object should be deleted.

By interacting with a complete button 1410 (labeled with “Ok”) displayed in user interface 1400, the user may indicate that preview of the encoded video objects is completed (and may cause encoded video objects selected in column 1408 to be deleted).

Note that user interface 1400 shown in FIG. 14 is provided for illustrative purposes. In further embodiments, user interface 1400 may be configured in other ways to enable user 710 to preview encoded video objects.

In step 810, the user is enabled to select at least one of the plurality of encoded video objects to be included in an online advertisement. For example, in an embodiment, user interface 708 may enable user 710 to select one or more of encoded video objects 714 to be included in an online advertisement (e.g., online advertisement object 300 of FIG. 3/online advertisement 400 of FIG. 4). User interface 708 may be configured in any manner, including one or more user interface elements, to enable user 710 to select encoded video objects 714. For example, in an embodiment, user interface 1400 of FIG. 14 may include a fourth column that includes a graphical user interface element (e.g., a selection box) that may be checked to indicate the corresponding encoded video object is to be included in an online advertisement. In another embodiment, all encoded video objects that are not selected for deletion in user interface 1400 may be designated to be included in the online advertisement. The online advertisement may be designated by the user in user interface 1400 (e.g., using a navigator, data entry box, etc.), or may be later designated by the user. In another embodiment, the user may be enabled to copy the filename(s) (e.g., URL address) shown in first column 1404 to an online advertisement (e.g., copy and paste) to include the corresponding encoded video object(s) in the online advertisement. In this manner, when displayed, the online advertisement calls the encoded video object(s) from storage 716, for example. In further embodiments, one or more of encoded video objects 714 may be included in an online advertisement in additional ways.

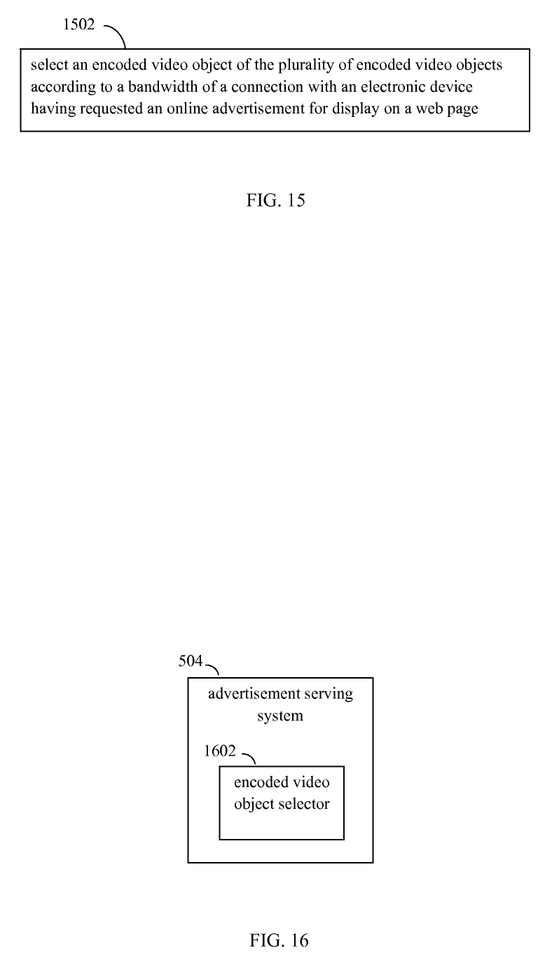

In embodiments, flowchart 600 of FIG. 6 and/or flowchart 800 of FIG. 8 may include the additional process of FIG. 15. FIG. 15 shows a process 1502. According to process 1502, an encoded video object of the plurality of encoded video objects is selected according to a bandwidth of a connection with an electronic device having requested an online advertisement for display on a web page. For example, in an embodiment, advertisement serving system 504 shown in FIG. 5 may include an encoded video object selector 1602, as shown in FIG. 16. When advertisement serving system 504 receives a request for an online advertisement that includes plurality of encoded video objects 714 (that were not rejected during the preview), an encoded video object of encoded video objects 714 is selected to be displayed in the online advertisement on a web page (e.g., online advertisement 402 of page 400 in FIG. 4). The encoded video object is selected according to a bandwidth of the electronic device (e.g., computer 102 of FIG. 1) that displays the web page. For example, if the electronic device has a lower bandwidth, a lower bitrate encoded video object may be selected. If the electronic device has a higher bandwidth, a higher bitrate encoded video object may be selected. The online advertisement, with the selected encoded video object, is served to the electronic device, and may be displayed at the device (e.g., by a browser of the electronic device).

### IV. Further Example Embodiments

Creative asset processing system 512, advertisement serving system 504, advertisement generator 506, creative asset processing system 700, user interface generator 702, video object validator 704, encoding module 706, scheduler 1006, video encoder 1008, encoding module 1200, send queue module 1204, poll queue module 1206, received queue module 1208, and encoded video object selector 1602 may be implemented in hardware, software, firmware, or any combination thereof. For example, creative asset processing system 512, advertisement serving system 504, advertisement generator 506, creative asset processing system 700, user interface generator 702, video object validator 704, encoding module 706, scheduler 1006, video encoder 1008, encoding module 1200, send queue module 1204, poll queue module 1206, received queue module 1208, and/or encoded video object selector 1602 may be implemented as computer program code configured to be executed in one or more processors. Alternatively, creative asset processing system 512, advertisement serving system 504, advertisement generator 506, creative asset processing system 700, user interface generator 702, video object validator 704, encoding module 706, scheduler 1006, video encoder 1008, encoding module 1200, send queue module 1204, poll queue module 1206, received queue module 1208, and/or encoded video object selector 1602 may be implemented as hardware logic/electrical circuitry.

First storage 716 and second storage 1202 may include long term and/or temporary storage, including one or more of any type of storage mechanism, such as a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

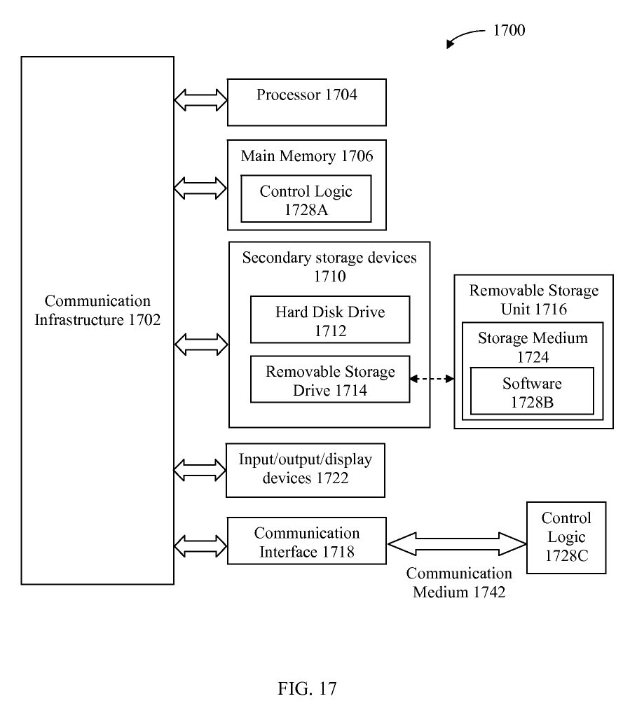

The embodiments described herein, including systems, methods/processes, and/or apparatuses, may be implemented using well known servers/computers. FIG. 17 depicts an exemplary implementation of a computer 1700 in which embodiments of the present invention may be implemented. For instance, computer 102, creative asset processing system 512, advertisement serving system 504, advertiser system/device 502, publisher web server(s) 508, user devices 510, creative asset processing system 700, first computer system 1002, second computer system 1004, etc., may be implemented in computers similar to computer 1700. Computer 1700 may be a general-purpose computing device in the form of a conventional personal computer, a mobile computer, or a workstation, for example, or computer 1700 may be a special purpose computing device. The description of computer 1700 provided herein is provided for purposes of illustration, and is not intended to be limiting. Embodiments of the present invention may be implemented in further types of computer systems, as would be known to persons skilled in the relevant art(s).

Computer 1700 can be any commercially available and well known computer capable of performing the functions described herein, such as computers available from International Business Machines, Apple, Sun, HP, Dell, Cray, etc. Computer 1700 may be any type of computer, including a desktop computer, a server, etc.

Computer 1700 includes one or more processors (also called central processing units, or CPUs), such as a processor 1704. Processor 1704 is connected to a communication infrastructure 1702, such as a communication bus. In some embodiments, processor 1704 can simultaneously operate multiple computing threads.

Computer 1700 also includes a primary or main memory 1706, such as random access memory (RAM). Main memory 1706 has stored therein control logic 1728A (computer software), and data.

Computer 1700 also includes one or more secondary storage devices 1710. Secondary storage devices 1710 include, for example, a hard disk drive 1712 and/or a removable storage device or drive 1714, as well as other types of storage devices, such as memory cards and memory sticks. For instance, computer 1700 may include an industry standard interface, such a universal serial bus (USB) interface for interfacing with devices such as a memory stick. Removable storage drive 1714 represents a floppy disk drive, a magnetic tape drive, a compact disk drive, an optical storage device, tape backup, etc.

Removable storage drive 1714 interacts with a removable storage unit 1716. Removable storage unit 1716 includes a computer useable or readable storage medium 1724 having stored therein computer software 1728B (control logic) and/or data. Removable storage unit 1716 represents a floppy disk, magnetic tape, compact disk, DVD, optical storage disk, or any other computer data storage device. Removable storage drive 1714 reads from and/or writes to removable storage unit 1716 in a well known manner.

Computer 1700 also includes input/output/display devices 1722, such as monitors, keyboards, pointing devices, etc.

Computer 1700 further includes a communication or network interface 1718. Communication interface 1718 enables the computer 1700 to communicate with remote devices. For example, communication interface 1718 allows computer 1700 to communicate over communication networks or mediums 1742 (representing a form of a computer useable or readable medium), such as LANs, WANs, the Internet, etc. Network interface 1718 may interface with remote sites or networks via wired or wireless connections.

Control logic 1728C may be transmitted to and from computer 1700 via the communication medium 1742.

Any apparatus or manufacture comprising a computer useable or readable medium having control logic (software) stored therein is referred to herein as a computer program product or program storage device. This includes, but is not limited to, computer 1700, main memory 1706, secondary storage devices 1710, and removable storage unit 1716. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include computer program logic for implementing creative asset processing system 512, advertisement serving system 504, advertisement generator 506, creative asset processing system 700, user interface generator 702, video object validator 704, encoding module 706, scheduler 1006, video encoder 1008, encoding module 1200, send queue module 1204, poll queue module 1206, received queue module 1208, encoded video object selector 1602, flowchart 600, flowchart 800, flowchart 1100, and/or process 1502 (including any one or more steps of flowcharts 600, 800, and/or 1100), and/or further embodiments of the present invention described herein. Embodiments of the invention are directed to computer program products comprising such logic (e.g., in the form of program code or software) stored on any computer useable or computer readable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### V. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
enabling a user to provide a video source object;
validating the video source object to determine whether the video source object meets at least one predetermined encoding factor;
encoding the video source object to generate a plurality of encoded video objects, each encoded video object having a corresponding bit rate;
enabling the user to preview each of the plurality of encoded video objects; and
enabling the user to select at least one of the plurality of encoded video objects to be included in an online advertisement.

2. The method of claim 1, wherein the at least one predetermined encoding factor includes at least one of a play time of the video source object, a file size of the video source object, or a file type of the video source object.

3. The method of claim 1, further comprising:
enabling the user to provide a second video source object to replace the first video source object if the first video source object does not meet the at least one predetermined encoding factor.

4. The method of claim 1, wherein said encoding comprises:
queuing the video source object in a send queue to be encoded by a video encoder;
transmitting the video source object to the video encoder;
polling the video encoder to determine whether the video source object has been encoded;
receiving the plurality of encoded video objects from the video encoder; and
storing the plurality of encoded video objects.

5. The method of claim 1, wherein said enabling the user to preview each of the plurality of encoded video objects comprises:
displaying a hyperlink corresponding to each of the plurality of encoded video objects that can be selected to display the corresponding encoded video object.

6. The method of claim 1, further comprising:
selecting an encoded video object of the plurality of encoded video objects according to a bandwidth of a connection with an electronic device having requested an online advertisement for display on a web page.

7. The method of claim 6, further comprising:
including a uniform resource locator (URL) for the encoded video object in the online advertisement.

8. A system, comprising:
a user interface generator configured to generate a user interface that enables a user to provide a video source object;
a video object validator configured to validate the video source object to determine whether the video source object meets at least one predetermined encoding factor; and
an encoding module configured to encode the video source object to generate a plurality of encoded video objects, each encoded video object having a corresponding bit rate;
wherein the user interface is configured to enable the user to preview each of the plurality of encoded video objects, and to enable the user to select at least one of the plurality of encoded video objects to be included in at least one online advertisement.

9. The system of claim 8, wherein the at least one predetermined encoding factor includes at least one of a play time of the video source object, a file size of the video source object, or a file type of the video source object.

10. The system of claim 8, wherein the user interface is configured to enable the user to provide a second video source object to replace the first video source object if the first video source object does not meet the at least one predetermined encoding factor.

11. The system of claim 8, wherein the encoding module includes:
a send queue module configured to queue the video source object in a send queue to be encoded by a video encoder, and to provide the video source object to the video encoder;
a poll queue module configured to poll the video encoder to determine whether the video source object has been encoded; and
a receive queue module configured to receive the plurality of encoded video objects from the video encoder, and to store the plurality of encoded video objects.

12. The system of claim 8, wherein the user interface is configured to display a hyperlink corresponding to each of the plurality of encoded video objects that can be selected to display the corresponding encoded video object for preview.

13. The system of claim 8, further comprising:
an encoded video object selector configured to select encoded video object of the plurality of encoded video objects according to a bandwidth of a connection with an electronic device having requested an online advertisement for display on a web page.

14. The system of claim 13, wherein the online advertisement includes a uniform resource locator (URL) for the selected encoded video object.

15. A computer program product comprising a computer-readable medium having computer program logic recorded thereon for enabling a processor to provide advertisements, comprising:
first computer program logic means for enabling the processor to enable a user to provide a video source object;
second computer program logic means for enabling the processor to validate the video source object to determine whether the video source object meets at least one predetermined encoding factor;
third computer program logic means for enabling the processor to encode the video source object to generate a plurality of encoded video objects, each encoded video object having a corresponding bit rate;
fourth computer program logic means for enabling the processor to enable the user to preview each of the plurality of encoded video objects; and
fifth computer program logic means for enabling the processor to enable the user to select at least one of the plurality of encoded video objects to be included in at least one online advertisement.

16. The computer program product of claim 15, further comprising:
sixth computer program logic means for enabling the processor to enable the user to provide a second video source object to replace the first video source object if the first video source object does not meet the at least one predetermined encoding factor.

17. The computer program product of claim 15, wherein said third computer program logic means comprises:
sixth computer program logic means for enabling the processor to queue the video source object in a send queue to be encoded by a video encoder;
seventh computer program logic means for enabling the processor to transmit the video source object to the video encoder;
eighth computer program logic means for enabling the processor to poll the video encoder to determine whether the video source object has been encoded;
ninth computer program logic means for enabling the processor to receive the plurality of encoded video objects from the video encoder; and
tenth computer program logic means for enabling the processor to store the plurality of encoded video objects.

18. The computer program product of claim 15, wherein said fourth computer program logic means comprises:
sixth computer program logic means for enabling the processor to display a hyperlink corresponding to each of the plurality of encoded video objects that can be selected to display the corresponding encoded video object.

19. The computer program product of claim 15, further comprising:
sixth computer program logic means for enabling the processor to select an encoded video object of the plurality of encoded video objects according to a bandwidth of a connection with an electronic device having requested an online advertisement for display on a web page.

20. The computer program product of claim 19, further comprising:
seventh computer program logic means for enabling the processor to include a uniform resource locator (URL) for the encoded video object in the online advertisement.
